(19) United States
(12) Patent Application Publication
(10) Pub. No.: US 2024/0231974 A1
(43) Pub. Date: Jul. 11, 2024

(54) METHOD AND SYSTEM FOR INTER-PROCESS COMMUNICATION

(71) Applicant: Beijing Bytedance Network Technology Co., Ltd., Beijing (CN)

(72) Inventor: Xiang LI, Beijing (CN)

(21) Appl. No.: 18/443,694

(22) Filed: Feb. 16, 2024

Related U.S. Application Data
(63) Continuation of application No. PCT/CN2022/102065, filed on Jun. 28, 2022.

(30) Foreign Application Priority Data
Nov. 25, 2021 (CN) 202111409285.0

(51) Int. Cl. G06F 9/54

(52) U.S. Cl. CPC G06F 9/547; G06F 9/546

(57) ABSTRACT

This specification provides methods and systems for inter-process communication. One of the methods includes, in response to monitoring a service registration in a Dbus bus of Linux®, adding a service synchronously in an Android® service manager. The method further includes in response to monitoring a service added in Android®, registering a service synchronously in the Dbus bus of Linux®. The method further includes when a Linux® process and an Android® process issue a service calling request, converting bidirectionally data structure transmitted between the Dbus and the Binder. This method can realize mutual calling of services between different inter-processes based on the synchronized registration/added services, thereby effectively simplifying an implementation process of bidirectional communication between the Linux® process and the Android® process.

### CROSS-REFERENCE TO RELATED APPLICATIONS

This application is a continuation application of, and claims priority to, PCT Application PCT/CN2022/102065, filed on Jun. 28, 2022, which claims priority to Chinese patent application Ser. No. 20/211,1409285.0, filed on Nov. 25, 2021, and entitled “Method and System for Inter-Process Communication.” The disclosure of the foregoing applications are incorporated herein by reference.

### BACKGROUND

### Field

The present specification relates to the field of computer technology, and more particularly to a method and system for inter-process communication.

### Background

Currently, a Linux® operating system process utilizes Binder (connector) to communicate with an Android® operating system process for inter-process and connects to the Android® Binder service through open source projects such as libgbinder. The IPC (inter-process communication) in Linux® desktop systems generally uses Dbus (desktop bus), which is easier for Linux® programs to use Dbus communication. However, open source projects such as libgbinder only support Linux® access to Android® Service, but cannot support Android® applications access to Linux® Service. Therefore, there is currently no simple and easy implementation solution for bidirectional communication between the Linux® process and the Android® process.

### SUMMARY

The present specification provides a method, a system, an electronic device, a storage medium, a computer program product, and a computer program for inter-process communication to solve the above technical problems. It is possible to simplify the implementation of bidirectional communication between the Linux® process and the Android® process.

The present specification provides a method of inter-process communication. The method of inter-process communication comprises: upon monitoring a message of a Linux® process registering a Linux® service, calling a service addition interface through a Binder device to cause a service manager to add a first synchronization service. The first synchronization service has a one-to-one correspondence with the Linux® service. The method of inter-process communication further comprises: upon monitoring a message of an Android® process adding an Android® service, issuing a service registration instruction to a Dbus bus to cause the Dbus bus to register a second synchronization service. The second synchronization service has a one-to-one correspondence with the Android® service.

In one embodiment, the method of inter-process communication further comprises upon receiving a first calling request from the Linux® process, forwarding the first calling request with structure converted to a target Android® service corresponding to the second synchronization service, and subsequently forwarding a first calling result fed back by the target Android® service to the Linux® process after a structural conversion. The method of inter-process communication further comprises upon receiving a second calling request from the Android® process, forwarding the second calling request with structure converted to a target Linux® service corresponding to the first synchronization service, and subsequently forwarding a second calling result fed back by the target Linux® service to the Android® process after a structural conversion.

In one embodiment, upon monitoring a message of an Android® process adding an Android® service, issuing a service registration instruction to a Dbus bus to cause the Dbus bus to register a second synchronization service comprises: upon monitoring the message of the Android® process adding the Android® service, issuing the service registration instruction to the Dbus bus to cause the Dbus bus to register the second synchronization service and to subsequently bind a handle identification of the Android® service in association with the second synchronization service.

In one embodiment, the method of inter-process communication further comprises: upon monitoring a message of the Linux® process logging out of the Linux® service, calling a service deletion interface through the Binder device to cause the service manager to delete the first synchronization service corresponding to the Linux® service.

In one embodiment, the method of inter-process communication further comprises: upon monitoring a message of the Android® process deleting the Android® service, issuing a service logout instruction to the Dbus bus to cause the Dbus bus to log out of the second synchronization service corresponding to the Android® service.

In one embodiment, upon receiving a first calling request from the Linux® process, forwarding the first calling request with structure converted to a target Android® service corresponding to the second synchronization service, and subsequently forwarding a first calling result fed back by the target Android® service to the Linux® process after a structural conversion comprises: upon receiving the first calling request sent by the Linux® process through the Dbus bus, converting a data structure of an incoming parameter of the first calling request into an Android® format; forwarding, through the Binder device, the first calling request with structure converted to the target Android® service corresponding to the second synchronization service; and receiving the first calling result fed back by the target Android® service according to the first calling request, and forwarding, through the Dbus bus, the first calling result with the structure converted to the Linux® process after converting a data structure of the first calling result into a Linux® format.

In one embodiment, upon receiving a second calling request from the Android® process, forwarding the second calling request with structure converted to a target Linux® service corresponding to the first synchronization service, and subsequently forwarding a second calling result fed back by the target Linux® service to the Android® process after a structural conversion comprises: upon receiving the second calling request sent by the Android® process through the binder device, converting a data structure of an incoming parameter of the second calling request into a Linux® format; forwarding, through the Dbus bus, the second calling request with structure converted to the target Linux® service corresponding to the first synchronization service; and receiving the second calling result fed back by the target Linux® service according to the second calling request, and forwarding, through the Binder device, the second calling result with structure converted to the Android® process after converting the data structure of the second calling result into the Android® format.

In one embodiment, the message of the Linux® process registering the Linux® service is issued by the Dbus bus after registering the Linux® service; the message of the Android® process adding the Android® service is issued by the Android® process after a determination that the Android® service is added.

The present specification also provides a system for inter-process communication. The system for inter-process communication comprises a first synchronization module configured to, upon monitoring a message of a Linux® process registering a Linux® service, call a service addition interface through a Binder device to cause a service manager to add a first synchronization service. The first synchronization service has a one-to-one correspondence with the Linux® service. The system for inter-process communication further comprises a second synchronization module configured to, upon monitoring a message of an Android® process adding an Android® service, issue a service registration instruction to a Dbus bus to cause the Dbus bus to register a second synchronization service. The second synchronization service has a one-to-one correspondence with the Android® service.

The present application also provides an electronic device including a memory, a processor and a computer program stored on the memory and executable on the processor, wherein the processor executes the program to cause the electronic device to perform operations that implement any of the above steps of the method of inter-process communication.

The present application also provides a non-transitory computer readable storage medium having a computer program stored thereon, the computer program, when executed by a processor of one or more computing devices, causes the one or more computing devices to perform operations that implement any of the above steps of the method of inter-process communication.

The present application also provides a computer program product, comprising a computer program that, when executed by a processor of one or more computing devices, causes the one or more computing devices to perform operations that implement any of the above steps of the method of inter-process communication.

The present specification also provides a computer program, when executed by a processor, implementing any of the above steps of the method of inter-process communication.

The present specification provides the method, system, electronic device and storage medium for inter-process communication, upon monitoring a service registration in a Dbus bus of Linux®, adding a service synchronously in an Android® service manager; upon monitoring a service added in Android®, registering a service synchronously in the Dbus bus of Linux®. It is possible to realize mutual calling of services between different inter-processes based on the synchronized registration/added services, thereby effectively simplifying an implementation process of bidirectional communication between the Linux® process and the Android® process.

### BRIEF DESCRIPTION OF THE DRAWINGS

To illustrate the technical solutions more clearly in this specification or the Prior Art, the following will briefly introduce accompanying drawings that need to be used in the description of embodiments or the Prior Art. Apparently, the accompanying drawings in the following description are some embodiments of this specification. For those skilled in the art, without creative efforts, other accompanying drawings can also be obtained based on these accompanying drawings.

FIG. 1 is a flowchart of a method of inter-process communication provided in the embodiments of the present specification.

FIG. 2 is a schematic diagram of an overall framework provided in the embodiments of the present specification.

FIG. 3 is a flowchart of a registration process of Linux® Dbus service provided in the embodiments of the present specification.

FIG. 4 is a flowchart of a logout process of Linux® Dbus service provided by the embodiment of the present specification.

FIG. 5 is a flowchart of an addition process of Android® Binder service provided by the embodiments of the present ap specification plication.

FIG. 6 is a flowchart of a deletion process of Android® Binder service provided by the embodiments of the present specification.

FIG. 7 is a flowchart of a Linux® process calling an Android® Binder service provided in the embodiments of the present specification.

FIG. 8 is a flowchart of an Android® process calling a Linux® Dbus service provided in the embodiments of the present specification.

FIG. 9 is a structural schematic diagram of a system for inter-process communication provided in the embodiments of the present specification.

FIG. 10 is a structural schematic diagram of an electronic device provided in the embodiments of the present specification.

### DETAILED DESCRIPTION

In order to make the purpose, technical solutions, and advantages of this application clearer, the technical solutions in this application will be clearly and completely described in conjunction with the accompanying drawings. Apparently, the described embodiments are part of the embodiments in this application, not all embodiments. Based on the embodiments in this application, all other embodiments obtained by those skilled in the art without creative labor are within the scope of protection of this application.

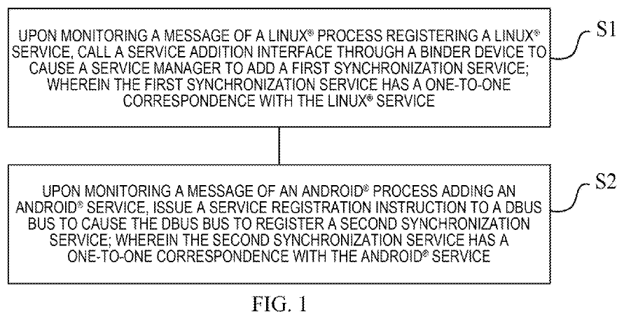

As shown in FIG. 1, the embodiments of the present application provide a method of inter-process communication, which may include steps of:

S1, upon monitoring a message of a Linux® process registering a Linux® service, a service addition interface is called through a Binder device to cause a service manager to add a first synchronization service. The first synchronization service has a one-to-one correspondence with the Linux® service; and

S2, upon monitoring a message of an Android® process adding an Android® service, a service registration instruction is issued to a Dbus bus to cause the Dbus bus to register a second synchronization service. The second synchronization service has a one-to-one correspondence with the Android® service.

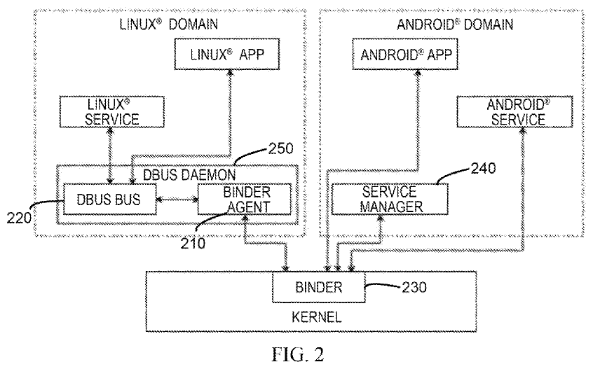

It should be noted that the key to solving the technical problems raised in the above background technology is how the DBus Bus and Binder synchronize all service states. As shown in FIG. 2, the embodiments of the present application may add a Binder Agent module 210, which is a core of associating Dbus Bus 220 and Binder 230. The Binder Agent module 210 may be used as an execution actor of the method of inter-process communication. It needs to implement the following functions:

1. The Binder Agent 210 may communicate with a ServiceManager 240, a Binder service (Android® service) and a client through a binder device.

2. The Binder Agent 210 connects to the Dbus bus 220 and may communicate with a Dbus service (Linux® service) and the client through the Dbus bus 220.

3. Monitor the service registration on the Dbus bus 220; when a new Dbus service is registered, the Binder Agent synchronously adds a service to the Service Manager 240.

4. Monitor the addition of services on the Binder; when a new Binder service is added, the Binder Agent 210 registers a service synchronously on the Dbus Bus 220.

5. The Binder Agent 210 realizes a bidirectional conversion of data structure between the Dbus and the Binder.

It should be noted that Dbus Daemon 250 is a background process responsible for message forwarding. It acts like a router. The Binder Agent 210 may be implemented in Dbus Daemon 250 or as a separate service. Considering performance factors, the embodiments of the present application place the Binder Agent 210 in Dbus Daemon 250 to improve system performance.

The method of inter-process communication provided by the embodiments of the present application, upon monitoring a service registration in a Dbus bus of Linux®, adds a service synchronously in an Android® service manager; upon monitoring a service added in Android®, registers a service synchronously in the Dbus bus of Linux®. Binder method that the Linux® process accesses the Android® service through the dbus interface may be implemented; Dbus method that the Android® process accesses the Linux® service through the Binder interface may be implemented. It is possible to realize mutual calling of services between different inter-processes based on the synchronized registration/added services, thereby effectively simplifying an implementation process of bidirectional communication between the Linux® process and the Android® process.

In one embodiment, the method of inter-process communication may further comprise:

S3, upon receiving a first calling request from the Linux®® process, the first calling request with structure converted is forwarded to a target Android® service corresponding to the second synchronization service, and subsequently a first calling result fed back by the target Android® service is forwarded to the Linux® process after a structural conversion.

S4, upon receiving a second calling request from the Android® process, the second calling request with structure converted is forwarded to a target Linux® service corresponding to the first synchronization service, and subsequently a second calling result fed back by the target Linux® service is forwarded to the Android® process after a structural conversion.

The method of inter-process communication provided by the embodiments of the present application, through bidirectional conversion of the data structure transmitted between Dbus and Binder, may implement the Binder method that the Linux® process accesses the Android® service through the dbus interface and the Dbus method that the Android® process accesses the Linux® service through the Binder interface. It is possible to realize mutual calling of services between different inter-processes based on the synchronized registration/added services, thereby effectively simplifying an implementation process of bidirectional communication between the Linux® process and the Android® process.

In one embodiment, upon monitoring a message of an Android® process adding an Android® service, issuing a service registration instruction to a Dbus bus to cause the Dbus bus to register a second synchronization service comprises:

upon monitoring the message of the Android® process adding the Android® service, issuing the service registration instruction to the Dbus bus to cause the Dbus bus to register the second synchronization service and to subsequently bind a handle identification of the Android® service in association with the second synchronization service.

The method of inter-process communication provided in the embodiments of the present application, through binding the handle identifier of the Android® service in association with the second synchronization service, so that when the Linux® process calls the Android® service, may find the handle corresponding to the service according to the handle identification, effectively improving the feasibility of service calling.

In one embodiment, the method of inter-process communication further comprises:

upon monitoring a message of the Linux® process logging out of the Linux® service, calling a service deletion interface through the Binder device to cause the service manager to delete the first synchronization service corresponding to the Linux® service.

The method of inter-process communication provided by the embodiments of the present application monitors the logout of the service on the Dbus bus. When a Dbus service logs out, the Binder Agent synchronously deletes the service on the Binder, thereby effectively improving the security and reliability of the system.

In one embodiment, the method of inter-process communication further comprises:

upon monitoring a message of the Android® process deleting the Android® service, issuing a service logout instruction to the Dbus bus to cause the Dbus bus to log out of the second synchronization service corresponding to the Android® service.

The method of inter-process communication provided by the embodiments of the present application monitors the deletion of the service on the Binder. When a Binder service is deleted, the Binder Agent synchronously logs out the service on the Dbus bus, thereby effectively improving the security and reliability of the system.

In one embodiment, upon receiving a first calling request from the Linux® process, forwarding the first calling request with structure converted to a target Android® service corresponding to the second synchronization service, and subsequently forwarding a first calling result fed back by the target Android® service to the Linux® process after a structural conversion comprises:

upon receiving the first calling request sent by the Linux® process through the Dbus bus, converting a data structure of an incoming parameter of the first calling request into an Android® format;

forwarding, through the Binder device, the first calling request with structure converted to the target Android® service corresponding to the second synchronization service; and

receiving the first calling result fed back by the target Android® service according to the first calling request, and forwarding, through the Dbus bus, the first calling result with the structure converted to the Linux® process after converting a data structure of the first calling result into a Linux® format.

The method of inter-process communication provided in the embodiments of the present application effectively simplify the code implementation of calling between Linux® and Android® systems by implementing bidirectional conversion of data structures between Android® and Linux®, and forwarding calling requests and calling results through the Dbus bus and Binder device.

In one embodiment, upon receiving a second calling request from the Android® process, forwarding the second calling request with structure converted to a target Linux® service corresponding to the first synchronization service, and subsequently forwarding a second calling result fed back by the target Linux® service to the Android® process after a structural conversion comprises:

upon receiving the second calling request sent by the Android® process through the binder device, converting a data structure of an incoming parameter of the second calling request into a Linux® format;

forwarding, through the Dbus bus, the second calling request with structure converted to the target Linux® service corresponding to the first synchronization service; and

receiving the second calling result fed back by the target Linux® service according to the second calling request, and forwarding, through the Binder device, the second calling result with structure converted to the Android® process after converting the data structure of the second calling result into the Android® format.

The method of inter-process communication provided in the embodiments of the present application effectively simplify the code implementation of calling between Linux® and Android® systems by implementing bidirectional conversion of data structures between Android® and Linux®, and forwarding calling requests and calling results through the Dbus bus and Binder device.

In one embodiment, the message of the Linux® process registering the Linux® service is issued by the Dbus bus after registering the Linux® service; the message of the Android® process adding the Android® service is issued by the Android® process after a determination that the Android® service is added.

The method of inter-process communication provided by the embodiments of the present application, sends a monitoring message to the Binder Agent by the Dbus bus according to the registration of the Linux® service, and sends a monitoring message by the Android® process to the Binder Agent according to the addition of the Android® service, which effectively simplifies the code implementation of calling between the Linux® and the Android® systems.

Based on the above solution, to better understand the method of inter-process communication provided in the embodiments of the present application, the following specific examples are listed in detail:

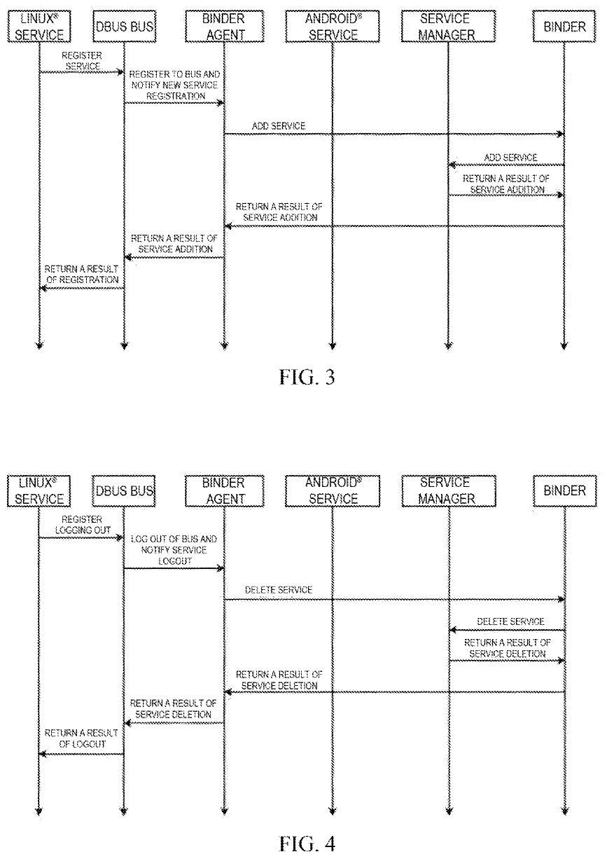

As shown in FIG. 3, the flow of registering Linux® Dbus service is as follows:

1, A Linux® service registration interface has not changed, and the Linux® service still calls a Dbus Bus interface to register the service.

2. After receiving the registration request, the Dbus Bus first registers the service on Bus. After the registration is successful, it notifies the Binder Agent module that there is a new service registration.

3. After receiving the notification of the new service registration, the Binder Agent module calls the standard addition service interface of Binder.

4. The addition service interface calls the service addition processing of the Service Manager through the Binder device.

5. After adding the corresponding first synchronization service, the Service Manager returns the result to the Binder Agent.

6. After receiving the result of the service addition, the Binder Agent returns the success or failure result to the Dbus Bus.

7. The Dbus Bus returns the result of the registration to the Linux® service according to the result of the service addition.

(2) As shown in FIG. 4, the logout flow of the Linux® Dbus service is as follows:

1. The Linux® service logout interface has not changed, and the Linux® service may still call the Dbus Bus interface to log out the service.

2. After receiving the logout request, the Dbus Bus first logs out the service on the Bus. After the logout is successful, it notifies the Binder Agent module that there is a service logout.

3. After receiving the service logout notification, the Binder Agent module calls the standard deletion service interface of the Binder.

4. The deletion service interface calls the service deletion processing of the Service Manager through the Binder device.

5. After deleting the corresponding first synchronization service, the Service Manager returns the result to the Binder Agent.

6. After receiving the result of the service deletion, the Binder Agent returns the success or failure result to the Dbus Bus.

7. The Dbus Bus returns the result of logout to the Linux® service according to the result of the service deletion.

As shown in FIG. 5, the addition flow of the Android® Binder service is as follows:

1. The Android® Binder service addition interface has not changed, and the Android® process still calls the Binder interface to add the service.

2. After receiving the service addition request, the Binder first adds the service to the Service Manager and sends the result of the service addition to the Android® service (Android® process).

3. After receiving the result of the addition and confirming that the Service Manager adds the service successfully, the Android® service sends the service addition notification through the Binder device.

4. After receiving the service addition notification, the Binder Agent module registers the corresponding Dbus service (second synchronization service) with the Dbus Bus according to the name of the added Android® service.

5. After the registration of the Dbus service is completed, the Binder Agent will initiate a obtaining service request.

6. After receiving the obtaining service request, the Service Manager returns a handle of the corresponding service.

7. After receiving the handle of the corresponding service, the Binder Agent associates the previously registered Dbus service with the binder handle.

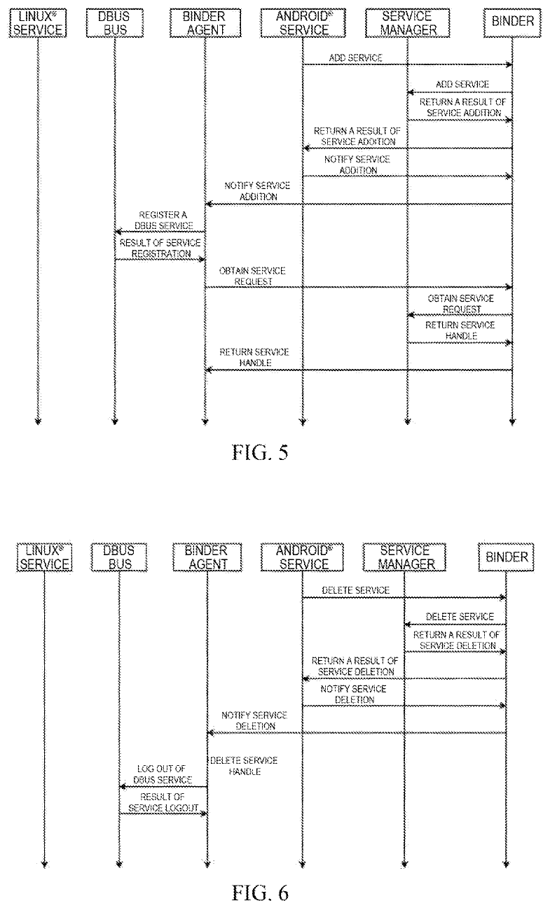

As shown in FIG. 6, the deletion flow of the Android® Binder service is as follows:

1. The Android® Binder service deletion interface has not changed, and the Android® process still calls the Binder interface to delete the service.

2. After receiving the service deletion request, the Binder first deletes the service on the Service Manager and sends the result of the service deletion to the Android® service (Android® process).

3. After the Android® service receives the result of deletion and confirms that the Service Manager deletes the service successfully, it sends a service deletion notification through the Binder device.

4. After receiving the service deletion notification, the Binder Agent module logs out the corresponding Dbus service (second synchronization service) from the Dbus Bus according to the name of the deleted Android® service.

5. After the logout of the Dbus service is completed, the result of the service logout is returned to the Binder Agent to initiate the obtaining service request.

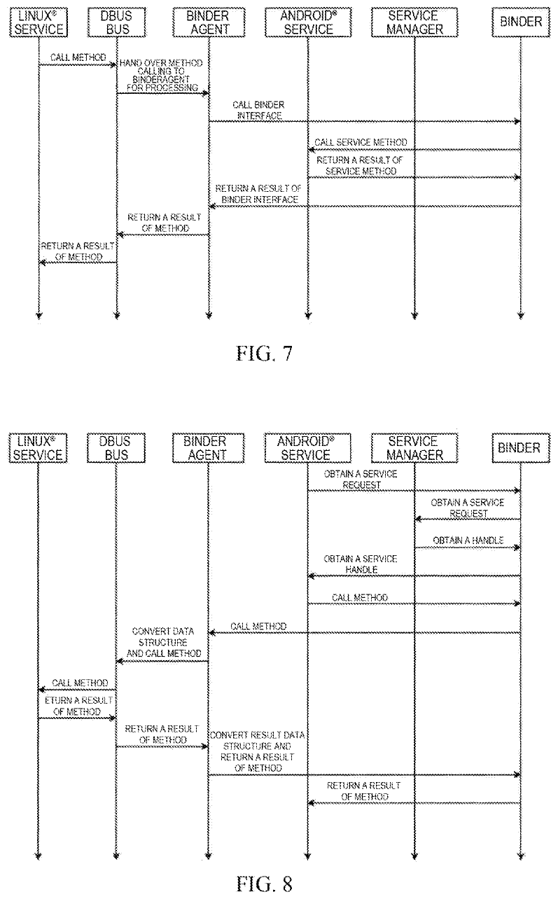

(5) As shown in FIG. 7, the flow that the Linux® process calls the Android® Binder service is as follows:

1. The Linux® process calls the Android® service interface, and still uses the standard dbus interface. The Linux® process sends the calling method to the Dbus Bus.

2. After receiving the calling method of the service, the Dbus bus may search for the service through the parameter—the service name of the calling method. If the found service is the service registered by the Binder Agent, the calling request is sent to the Binder Agent for processing.

3. After receiving the calling request, the Binder Agent searches for the corresponding service handle according to the service name and converts the data structure of the incoming parameter into an Android® sequence according to the conversion rules. After these are completed, the converted calling request is sent to the corresponding service handle through the binder device.

4. After receiving the method call, the Android® service executes the method processing and returns the processing result. This step is the same as other normal Android® process calling.

5. After receiving the result returned by the Android® service (by calling the Binder interface), the Binder Agent converts the data structure of the result into a Linux® sequence. After completion, it sends the result to the Dbus Bus.

6. After receiving the method result, the Dbus Bus returns it to the Linux® process through the standard Dbus interface.

7. The Linux® process receives the processing result of the Android® service.

(6) As shown in FIG. 8, the flow that the Android® process calls the Linux® Dbus service is as follows:

1. The Android® process first sends the obtaining service request to the Service Manager. The Android® process calls the Linux® service interface, which is still the standard Binder flow for the Android® process.

2. After receiving the obtaining service request sent by the Android® process, the Service Manager will search according to the service name. Since the Linux® service was added through the Binder Agent when registering, the corresponding handle may be found through the service name. The Service Manager returns the handle corresponding to the Linux® service to the Android® process.

3. After receiving the handle corresponding to the Linux® service, the Android® process calls the method through the binder device.

4. After receiving the binder calling request, the Binder Agent converts the data structure of the called parameter into a Linux® sequence. At the same time, according to the service processing of the request, the name of the Linux® Dbus service is obtained. The Binder Agent sends the method to the corresponding Linux® service (Dbus service) through the Dbus Bus.

5. After receiving the method request sent by the Binder Agent, the Dbus Bus sends the method to the corresponding Linux® service.

6, After receiving the method calling, after processing is completed, the Linux® returns the result to the Dbus Bus. The steps 5-6 are consistent with the standard dbus flow.

7. After receiving the method result, the Dbus bus sends the result to the Binder Agent.

8. After receiving the method result, the Binder Agent converts the data structure of the result into an Android® sequence and returns the result to the Android® process.

9. The Android® process may call the Linux® service method through the Binder and obtain the relevant method result.

It should be noted that the integration of inter-process communication between the Dbus and the Binder through the embodiments of the present application simplifies the calling code implementation between the Linux® and Android® systems, and calling between cross-systems can be realized by using the standard interfaces of the respective systems.

The following describes a system for inter-process communication provided by the present application, and the system for inter-process communication described below may correspond to each other with reference to the method of inter-process communication described above.

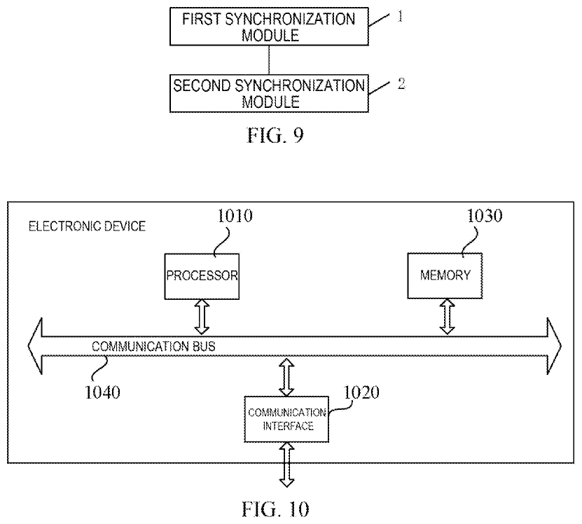

Referring to FIG. 9, the embodiments of the present application further provide a system for inter-process communication, comprising:

a first synchronization module configured to, upon monitoring a message of a Linux® process registering a Linux® service, call a service addition interface through a Binder device to cause a service manager to add a first synchronization service; wherein the first synchronization service has a one-to-one correspondence with the Linux® service; and

a second synchronization module configured to, upon monitoring a message of an Android® process adding an Android® service, issue a service registration instruction to a Dbus bus to cause the Dbus bus to register a second synchronization service; wherein the second synchronization service has a one-to-one correspondence with the Android® service.

In one embodiment, the system for inter-process communication further comprises:

a first calling module configured to, upon receiving a first calling request from the Linux® process, forward the first calling request with structure converted to a target Android® service corresponding to the second synchronization service, and subsequently forwarding a first calling result fed back by the target Android® service to the Linux® process after a structural conversion; and

a second calling module configured to, upon receiving a second calling request from the Android® process, forward the second calling request with structure converted to a target Linux® service corresponding to the first synchronization service, and subsequently forwarding a second calling result fed back by the target Linux® service to the Android® process after a structural conversion.

In one embodiment, the second synchronization module is specifically configured to:

upon monitoring the message of the Android® process adding the Android® service, issue the service registration instruction to the Dbus bus to cause the Dbus bus to register the second synchronization service and to subsequently bind a handle identification of the Android® service in association with the second synchronization service.

In one embodiment, the system for inter-process communication further comprises:

a synchronization deletion module configured to, upon monitoring a message of the Linux® process logging out of the Linux® service, call a service deletion interface through the Binder device to cause the service manager to delete the first synchronization service corresponding to the Linux® service.

In one embodiment, the system for inter-process communication further comprises:

a synchronization logout module configured to, upon monitoring a message of the Android® process deleting the Android® service, issue a service logout instruction to the Dbus bus to cause the Dbus bus to log out of the second synchronization service corresponding to the Android® service.

In one embodiment, the first calling module is specifically configured to:

upon receiving the first calling request sent by the Linux® process through the Dbus bus, convert a data structure of an incoming parameter of the first calling request into an Android® format;

forward, through the Binder device, the first calling request with structure converted to the target Android® service corresponding to the second synchronization service; and

receive the first calling result fed back by the target Android® service according to the first calling request, and forward, through the Dbus bus, the first calling result with the structure converted to the Linux® process after converting a data structure of the first calling result into a Linux® format.

In one embodiment, the second calling module is specifically configured to:

upon receiving the second calling request sent by the Android® process through the binder device, converting a data structure of an incoming parameter of the second calling request into a Linux® format;

forwarding, through the Dbus bus, the second calling request with structure converted to the target Linux® service corresponding to the first synchronization service; and

receiving the second calling result fed back by the target Linux® service according to the second calling request, and forwarding, through the Binder device, the second calling result with structure converted to the Android® process after converting the data structure of the second calling result into the Android® format.

In one embodiment, the message of the Linux® process registering the Linux® service is issued by the Dbus bus after registering the Linux® service; the message of the Android® process adding the Android® service is issued by the Android® process after a determination that the Android® service is added.

It should be understood that the above-described system item embodiments correspond to the method item embodiments of the present application. The system for inter-process communication provided by the embodiments of the present application can implement the method of inter-process communication provided by any of the method item embodiments of the present application.

The working principle of the system for inter-process communication in the embodiments of the this case is corresponding to the method of inter-process communication in the above embodiments, and will not be repeated here.

FIG. 10 illustrates a schematic diagram of a physical structure of an electronic device. As shown in FIG. 10, the electronic device may include: a processor 1010, a communication interface 1020, a memory 1030, and a communication bus 1040. The processor 1010, the communication interface 1020, and the memory 1030 complete communication with each other through the communication bus 1040. The processor 1010 may call logical instructions in the memory 1030 to perform the method of inter-process communication. The method includes: upon monitoring a message of a Linux® process registering a Linux® service, calling a service addition interface through a Binder device to cause a service manager to add a first synchronization service; wherein the first synchronization service has a one-to-one correspondence with the Linux® service; and upon monitoring a message of an Android® process adding an Android® service, issuing a service registration instruction to a Dbus bus to cause the Dbus bus to register a second synchronization service; wherein the second synchronization service has a one-to-one correspondence with the Android® service.

In addition, the above-mentioned logical instructions in the memory 1030 may be implemented in the form of software functional units and may be stored in a computer-readable storage medium when sold or used as independent products. Based on this understanding, the technical solution of the present application essentially or the part that contributes to Prior Art or the part of the technical solution may be embodied in the form of a software product, which is stored in a storage medium and includes several instructions to enable a computer device (which may be a personal computer, a server, or a network device, etc.) to perform all or part of the steps of the methods described in various embodiments of the present application. The aforementioned storage medium includes U disk, mobile hard disk, Read-Only Memory (ROM), Random Access Memory (RAM), magnetic disk or optical disk, and various media that may store program code.

On the other aspect, the present application also provides a computer program product comprising a computer program stored on a non-transitory computer readable storage medium, the computer program comprising program instructions, when executed by a computer, the computer may perform the method of inter-process communication provided by the above embodiments, and the method comprises: upon monitoring a message of a Linux® process registering a Linux® service, calling a service addition interface through a Binder device to cause a service manager to add a first synchronization service; wherein the first synchronization service has a one-to-one correspondence with the Linux® service; and upon monitoring a message of an Android® process adding an Android® service, issuing a service registration instruction to a Dbus bus to cause the Dbus bus to register a second synchronization service; wherein the second synchronization service has a one-to-one correspondence with the Android® service.

In yet another aspect, the present application also provides a non-transitory computer readable storage medium having a computer program stored thereon, the computer program, when executed by a processor, is implemented to perform the method of inter-process communication provided by the above-described embodiments. The method comprises: upon monitoring a message of a Linux® process registering a Linux® service, calling a service addition interface through a Binder device to cause a service manager to add a first synchronization service; wherein the first synchronization service has a one-to-one correspondence with the Linux® service; and upon monitoring a message of an Android® process adding an Android® service, issuing a service registration instruction to a Dbus bus to cause the Dbus bus to register a second synchronization service; wherein the second synchronization service has a one-to-one correspondence with the Android® service.

In yet another aspect, the present application also provides a computer program, the computer program, when executed by the processor, implementing the method of inter-process communication provided in various embodiments. The method comprises: upon monitoring a message of a Linux® process registering a Linux® service, calling a service addition interface through a Binder device to cause a service manager to add a first synchronization service; wherein the first synchronization service has a one-to-one correspondence with the Linux® service; and upon monitoring a message of an Android® process adding an Android® service, issuing a service registration instruction to a Dbus bus to cause the Dbus bus to register a second synchronization service; wherein the second synchronization service has a one-to-one correspondence with the Android® service.

The system embodiments described above are merely illustrative. The units described as separate components may or may not be physically separated. The components displayed as units may or may not be physical units, that is, they may be located in one place or distributed across multiple network units. Some or all of the modules may be selected according to actual needs to achieve the purpose of the solution of this embodiment. Those skilled in the art may understand and implement the method without any creative labor.

Through the above description of the implementations, those skilled in the art may clearly understand that each implementation may be implemented by software plus a necessary universal hardware platform, and of course, it may also be implemented by hardware. Based on this understanding, the above technical solution essentially or the part that contributes to Prior Art may be embodied in the form of a software product, which may be stored in a computer readable storage medium, such as ROM/RAM, magnetic disk, optical disk, etc., including several instructions to make a computer device (which may be a personal computer, a server, or a network device, etc.) perform certain parts of the methods described in each implementation or embodiment.

Finally, it should be noted that: the above embodiments are only used to illustrate the technical solutions of the present application, and not to limit them; although the present application has been described in detail with reference to the foregoing embodiments, those skilled in the art should understand: it is still possible to modify the technical solutions described in the foregoing embodiments, or to replace some of the technical features equivalently; and these modifications or substitutions do not make the essence of the corresponding technical solutions depart from the spirit and scope of the technical solutions of the embodiments of the present application.

1. A method of inter-process communication, comprising:
in response to monitoring a message of a Linux® process registering a Linux® service, calling a service addition interface through a Binder device to cause a service manager to add a first synchronization service; wherein the first synchronization service has a one-to-one correspondence with the Linux® service; and
in response to monitoring a message of an Android® process adding an Android® service, issuing a service registration instruction to a Dbus bus to cause the Dbus bus to register a second synchronization service; wherein the second synchronization service has a one-to-one correspondence with the Android® service.

2. The method of inter-process communication of claim 1, further comprising:
in response to receiving a first calling request from the Linux® process, forwarding the first calling request with structure converted to a target Android® service corresponding to the second synchronization service, and subsequently forwarding a first calling result fed back by the target Android® service to the Linux® process after a structural conversion; and
in response to receiving a second calling request from the Android® process, forwarding the second calling request with structure converted to a target Linux® service corresponding to the first synchronization service, and subsequently forwarding a second calling result fed back by the target Linux® service to the Android® process after a structural conversion.

3. The method of inter-process communication of claim 1, wherein in response to monitoring a message of an Android® process adding an Android® service, issuing a service registration instruction to a Dbus bus to cause the Dbus bus to register a second synchronization service comprises:
in response to monitoring the message of the Android® process adding the Android® service, issuing the service registration instruction to the Dbus bus to cause the Dbus bus to register the second synchronization service and to subsequently bind a handle identification of the Android® service in association with the second synchronization service.

4. The method of inter-process communication of claim 1, further comprising:
in response to monitoring a message of the Linux® process logging out of the Linux® service, calling a service deletion interface through the Binder device to cause the service manager to delete the first synchronization service corresponding to the Linux® service.

5. The method of inter-process communication of claim 1, further comprising:
in response to monitoring a message of the Android® process deleting the Android® service, issuing a service logout instruction to the Dbus bus to cause the Dbus bus to log out of the second synchronization service corresponding to the Android® service.

6. The method of inter-process communication of claim 2, wherein in response to receiving a first calling request from the Linux® process, forwarding the first calling request with structure converted to a target Android® service corresponding to the second synchronization service, and subsequently forwarding a first calling result fed back by the target Android® service to the Linux® process after a structural conversion comprises:
in response to receiving the first calling request sent by the Linux® process through the Dbus bus, converting a data structure of an incoming parameter of the first calling request into an Android® format;
forwarding, through the Binder device, the first calling request with structure converted to the target Android® service corresponding to the second synchronization service; and
receiving the first calling result fed back by the target Android® service according to the first calling request, and forwarding, through the Dbus bus, the first calling result with the structure converted to the Linux® process after converting a data structure of the first calling result into a Linux® format.

7. The method of inter-process communication of claim 2, wherein in response to receiving a second calling request from the Android® process, forwarding the second calling request with structure converted to a target Linux® service corresponding to the first synchronization service, and subsequently forwarding a second calling result fed back by the target Linux® service to the Android® process after a structural conversion comprises:
in response to receiving the second calling request sent by the Android® process through the binder device, converting a data structure of an incoming parameter of the second calling request into a Linux® format;
forwarding, through the Dbus bus, the second calling request with structure converted to the target Linux® service corresponding to the first synchronization service; and
receiving the second calling result fed back by the target Linux® service according to the second calling request, and forwarding, through the Binder device, the second calling result with structure converted to the Android® process after converting the data structure of the second calling result into an Android® format.

8. The method of inter-process communication of claim 1, wherein the message of the Linux® process registering the Linux® service is issued by the Dbus bus after registering the Linux® service; and wherein the message of the Android® process adding the Android® service is issued by the Android® process after a determination that the Android® service is added.

9. An electronic device comprising a memory, a processor and a computer program stored on the memory and executable on the processor, wherein the processor executes the program to cause the electronic device to perform operations of inter-process communication, the operations comprising:
in response to monitoring a message of a Linux® process registering a Linux® service, calling a service addition interface through a Binder device to cause a service manager to add a first synchronization service; wherein the first synchronization service has a one-to-one correspondence with the Linux® service; and
in response to monitoring a message of an Android® process adding an Android® service, issuing a service registration instruction to a Dbus bus to cause the Dbus bus to register a second synchronization service; wherein the second synchronization service has a one-to-one correspondence with the Android® service.

10. The device of claim 9, the operations further comprising:
in response to receiving a first calling request from the Linux® process, forwarding the first calling request with structure converted to a target Android® service corresponding to the second synchronization service, and subsequently forwarding a first calling result fed back by the target Android® service to the Linux® process after a structural conversion; and
in response to receiving a second calling request from the Android® process, forwarding the second calling request with structure converted to a target Linux® service corresponding to the first synchronization service, and subsequently forwarding a second calling result fed back by the target Linux® service to the Android® process after a structural conversion.

11. The device of claim 9, wherein in response to monitoring a message of an Android® process adding an Android® service, issuing a service registration instruction to a Dbus bus to cause the Dbus bus to register a second synchronization service comprises:
in response to monitoring the message of the Android® process adding the Android® service, issuing the service registration instruction to the Dbus bus to cause the Dbus bus to register the second synchronization service and to subsequently bind a handle identification of the Android® service in association with the second synchronization service.

12. The device of claim 9, the operations further comprising:
in response to monitoring a message of the Linux® process logging out of the Linux® service, calling a service deletion interface through the Binder device to cause the service manager to delete the first synchronization service corresponding to the Linux® service.

13. The device of claim 9, the operations further comprising:
in response to monitoring a message of the Android® process deleting the Android® service, issuing a service logout instruction to the Dbus bus to cause the Dbus bus to log out of the second synchronization service corresponding to the Android® service.

14. The device of claim 10, wherein in response to receiving a first calling request from the Linux® process, forwarding the first calling request with structure converted to a target Android® service corresponding to the second synchronization service, and subsequently forwarding a first calling result fed back by the target Android® service to the Linux® process after a structural conversion comprises:
in response to receiving the first calling request sent by the Linux® process through the Dbus bus, converting a data structure of an incoming parameter of the first calling request into an Android® format;
forwarding, through the Binder device, the first calling request with structure converted to the target Android® service corresponding to the second synchronization service; and
receiving the first calling result fed back by the target Android® service according to the first calling request, and forwarding, through the Dbus bus, the first calling result with the structure converted to the Linux® process after converting a data structure of the first calling result into a Linux® format.

15. The device of claim 10, wherein in response to receiving a second calling request from the Android® process, forwarding the second calling request with structure converted to a target Linux® service corresponding to the first synchronization service, and subsequently forwarding a second calling result fed back by the target Linux® service to the Android® process after a structural conversion comprises:
in response to receiving the second calling request sent by the Android® process through the binder device, converting a data structure of an incoming parameter of the second calling request into a Linux® format;
forwarding, through the Dbus bus, the second calling request with structure converted to the target Linux® service corresponding to the first synchronization service; and
receiving the second calling result fed back by the target Linux® service according to the second calling request, and forwarding, through the Binder device, the second calling result with structure converted to the Android® process after converting the data structure of the second calling result into an Android® format.

16. The device of claim 9, wherein the message of the Linux® process registering the Linux® service is issued by the Dbus bus after registering the Linux® service; and wherein the message of the Android® process adding the Android® service is issued by the Android® process after a determination that the Android® service is added.

17. A non-transitory computer readable storage medium having a computer program stored thereon, wherein the computer program, when executed by a processor, implements acts of inter-process communication, the acts comprising:
in response to monitoring a message of a Linux® process registering a Linux® service, calling a service addition interface through a Binder device to cause a service manager to add a first synchronization service; wherein the first synchronization service has a one-to-one correspondence with the Linux® service; and
in response to monitoring a message of an Android® process adding an Android® service, issuing a service registration instruction to a Dbus bus to cause the Dbus bus to register a second synchronization service; wherein the second synchronization service has a one-to-one correspondence with the Android® service.

18. The storage medium of claim 17, the acts further comprising:
in response to receiving a first calling request from the Linux® process, forwarding the first calling request with structure converted to a target Android® service corresponding to the second synchronization service, and subsequently forwarding a first calling result fed back by the target Android® service to the Linux® process after a structural conversion; and
in response to receiving a second calling request from the Android® process, forwarding the second calling request with structure converted to a target Linux® service corresponding to the first synchronization service, and subsequently forwarding a second calling result fed back by the target Linux® service to the Android® process after a structural conversion.

19. The storage medium of claim 17, wherein in response to monitoring a message of an Android® process adding an Android® service, issuing a service registration instruction to a Dbus bus to cause the Dbus bus to register a second synchronization service comprises:
in response to monitoring the message of the Android® process adding the Android® service, issuing the service registration instruction to the Dbus bus to cause the Dbus bus to register the second synchronization service and to subsequently bind a handle identification of the Android® service in association with the second synchronization service.

20. The storage medium of claim 17, the acts further comprising:
in response to monitoring a message of the Linux® process logging out of the Linux® service, calling a service deletion interface through the Binder device to cause the service manager to delete the first synchronization service corresponding to the Linux® service.
